(19) United States
(12) Patent Application Publication
(10) Pub. No.: US 2009/0160205 A1
(43) Pub. Date: Jun. 25, 2009

(54) CROSS BAR OF ROOF CARRIER FOR VEHICLES

(75) Inventors: Han Young Kim, Gwangmyeong-si (KR); Chang Tae Lee, Daegu (KR)

Correspondence Address: MORGAN, LEWIS & BOCKIUS LLP (SF), One Market, Spear Street Tower, Suite 2800, San Francisco, CA, 94105, US

(73) Assignees: HYUNDAI MOTOR COMANY, Seoul (KR); KIA MOTORS CORPORATION, Seoul (KR); ECO-PLASTIC CORPORATION, Gyeongsangbuk-do (KR)

(21) Appl. No.: 12/276,259

(22) Filed: Nov. 21, 2008

(30) Foreign Application Priority Data
Dec. 12, 2007 (KR) 10-2007-0131015

(51) Int. Cl. B60P 3/00

(52) U.S. Cl. 296/3

(57) ABSTRACT

Disclosed is a cross bar of a roof carrier for vehicles, which is transversely mounted between side bars provided on opposite sides of a roof in such a way as to move between the side bars, and uses one wire to provide a simple structure. The cross bar includes locking pins, a wire, and a handle. The locking pins are provided on opposite ends of a bar body in such a way as to be elastically ejected out and be selectively locked to side bars. The wire is provided in the bar body and couples the locking pins to each other. The handle is provided between the locking pins to hold the wire and is constructed to be elastically restored to an original state thereof after the handle is rotated, so that, when the handle is rotated, the wire is wound to retract the locking pins into the bar body.

### CROSS-REFERENCE TO RELATED APPLICATIONS

This application claims priority to Korean Application No. 10-2007-0131015, filed on Dec. 12, 2007, the disclosure of which is incorporated herein by reference.

### BACKGROUND OF THE INVENTION

1. Field of the Invention

The present invention relates to a cross bar of a roof carrier for vehicles, and more particularly to a cross bar of a roof carrier for vehicles which is transversely mounted between side bars which are provided on opposite sides of a roof, and is movably fastened between the side bars.

2. Description of the Related Art

In order to load goods on a vehicle when cargo space in the vehicle is lacking, a roof carrier is mounted to a roof of the vehicle. The roof carrier includes side bars and cross bars so as to firmly fasten leisure equipment or other objects to the vehicle.

The side bars of the roof carrier are provided on both sides of a roof panel in such a way as to extend in the longitudinal direction of the vehicle. Each cross bar is installed between the two side bars so as to hold loaded goods.

It is necessary to adjust the position of the cross bar according to the size of the cargo. Thus, the cross bar is selectively secured to a position between the side bars, or can be slid to change its position.

The conventional method of mounting the cross bar is as follows. That is, locking pins are provided on both ends of the cross bar, and a plurality of pin insert holes is formed in the side bars to correspond to the locking pins. When the locking pins of the cross bar are ejected out from and are inserted into the pin insert holes, the cross bar is mounted at a desired position. Conversely, when the locking pins are retracted into the cross bar, the locking pins are removed from the pin insert holes, so that the cross bar can slide along the side bars. After the cross bar is located at a desired position, the locking pins are ejected out from the cross bar, so that the cross bar is mounted to the position.

A conventional cross bar of a roof carrier for vehicles will be described. Side bars are provided on both side ends of a roof panel of a vehicle in such a way as to extend in the longitudinal direction of the vehicle. Cross bars are movably installed between the side bars. The mounting structure of the cross bars and the side bars is as follows. Each cross bar includes a body and brackets which are provided on both ends of the body. A locking pin is provided on the end of each bracket. A plurality of pin insert holes is formed in each side bar so that the corresponding locking pin is inserted into a desired pin insert hole. Each cross bar is movably secured between the side bars using the locking pins.

Thus, the gist of the cross-bar mounting technique pertains to the selective ejection or retraction of the locking pins. In order to realize this technique, generally, pull-type handles are provided on both ends of the cross bar, and are coupled to the locking pins using two wires in such a way that the handle provided on one end of the cross bar is coupled to the locking pin provided on the other end of the cross bar using one wire.

The conventional cross-bar mounting structure uses a cam. That is, when the lever-type handle provided on one end is operated, the locking pin provided on the other end is simultaneously moved, so that the cross bar moves along side rails provided on the inner surfaces of side bars, thus allowing the position of the cross bar to be changed through the manipulation of one person. However, since the cross-bar mounting structure must be designed in consideration of the rotation of the cam, an opening must be provided under the handle. This undesirably generates noise and leads to a complicated construction due to the use of a plurality of springs. Further, two wires are required, thus reducing durability and increasing the cost of a product.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, embodiments of the present invention provides a cross bar of a roof carrier for vehicles, which uses one wire to provide a simple internal structure, thus increasing durability and reducing the cost of a product.

In order to accomplish the above object, the present invention provides a cross bar of a roof carrier for vehicles, including at least a locking pin provided on opposite ends of a bar body of the cross bar and capable of being elastically ejected out, a wire provided in the bar body and coupling the locking pins to each other, and a handle provided between the locking pins to hold the wire, and constructed to be rotated to wind the wire and thus retract the locking pin into the bar body of the cross bar and constructed to be elastically restored to an original state thereof to unwind the wire when the handle is released.

The handle may comprise a hinge shaft configured to vertically pass through the bar body, a grip part provided on an upper end of the hinge shaft and rotatable with respect to the hinge shaft by a rotating force, wherein a lower portion of the grip part is configured to be rotatably inserted into a portion of the bar body, a base part provided under a lower end of the hinge shaft and secured to the bar body, wherein the lower part of the grip part is rotatably mounted onto the base part, a shaft spring provided around the hinge shaft, wherein both ends of the shaft spring are supported by the grip part and the base part respectively, and a takeup part rotatably provided between the hinge shaft and base part, wherein the wire passes through the lower portion of the grip part and the takeup part, and the takeup part is coupled to the grip part.

The grip part may further comprise: an activation portion extending downwards from the upper portion of the grip part and disposed substantially around the hinge shaft, the activation portion being coupled to a portion of the takeup part to rotate the takeup part, and a receiving slot formed along a portion of outer circumference of the grip part and a portion of circumference of the activation portion to receive the wire.

The stoppers may be provided on the base part and placed respectively on opposite sides of the takeup part with respect to a longitudinal direction thereof, and serves to limit rotation of the takeup part. One opening between stoppers is configured to face one of the at least a locking pin with a first predetermined angle and the other opening between stoppers may be configured to face the other of the at least a locking pin with a second predetermined angle. The first predetermined angle and the second predetermined angle may be substantially the same.

A locking projection may be provided on a portion of the wire positioned inside the takeup part, and is locked to the takeup part along a longitudinal direction thereof, thus preventing the wire from slipping when the takeup part rotates.

At least a guide part maybe provided on the base part and positioned substantially next to the wire, and allows the wire to be wound without deviating from a predetermined course. The at least a guide part may be positioned in a rotational direction of the grip part turned by a user. The at least a guide part may include a roller to point-support the wire.

In another exemplary embodiment of the present invention, a mounting bracket may be provided on an end of the bar body, and one of the at least a locking pin, provided on an associated end of the bar body, and the handle are mounted to the mounting bracket, the locking pin being connected via a pin spring to a pin holder provided on the mounting bracket such that the locking pin is elastically ejected by the locking pin when the handle is released.

The handle may comprise a grip part, wherein a lower portion of the grip shaft is slidably inserted into a portion of the mounting bracket the grip part subjected to a rotating force, a hinge shaft extending downwards substantially from a center of an upper portion of the grip part, wherein the grip part is rotatable with respect to the hinge shaft by the rotating force, a takeup part rotatably provided under the hinge shaft, wherein the wire passes though the lower part of the grip part and the takeup part, and the takeup part is coupled to the grip part, a base part provided under the takeup part and secured to the mounting bracket and a shaft spring provided around the hinge shaft, wherein both ends of the shaft spring are supported by the grip part and the base part respectively.

The grip part may further comprise an activation portion extending downwards from the upper portion of the grip part and disposed substantially around the hinge shaft, the activation portion being coupled to a portion of the takeup part to rotate the takeup part and a receiving slot formed along a portion of outer circumference of the grip part and a portion of circumference of the activation portion to receive the wire.

The stoppers may be provided on the base part and placed respectively on opposite sides of the takeup part with respect to a longitudinal direction thereof, and serve to limit rotation of the takeup part. One opening between stoppers may be configured to face one of the at least a locking pin with a first predetermined angle and the other opening between stoppers is configured to face the other of the at least a locking pin with a second predetermined angle. The first predetermined angle and the second predetermined angle may be substantially the same.

A locking projection may be provided on a portion of the wire positioned inside the takeup part, and is locked to the takeup par along a longitudinal direction thereof, thus preventing the wire from slipping when the takeup part rotates.

At least a guide part may be provided on the base part and positioned substantially next to the wire and, allows the wire to be wound without deviating from a predetermined course. The at least a guide part may be positioned in a rotational direction of the grip part turned by a user. The at least a guide part may include a roller to point-support the wire.

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIG. 1 is a perspective view showing the internal construction of a cross bar of a roof carrier for vehicles, according to an embodiment of the present invention;

FIG. 2 is another perspective view showing the internal construction of the cross bar of the roof carrier for vehicles, which is shown in FIG. 1; and

FIG. 3 is a partial cutaway perspective view showing the internal construction of the cross bar of the roof carrier for vehicles, which is shown in FIG. 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF THE PREFERRED EMBODIMENTS

Hereinafter, a cross bar of a roof carrier for vehicles, according to the preferred embodiment of the present invention, will be described with reference to the accompanying drawings.

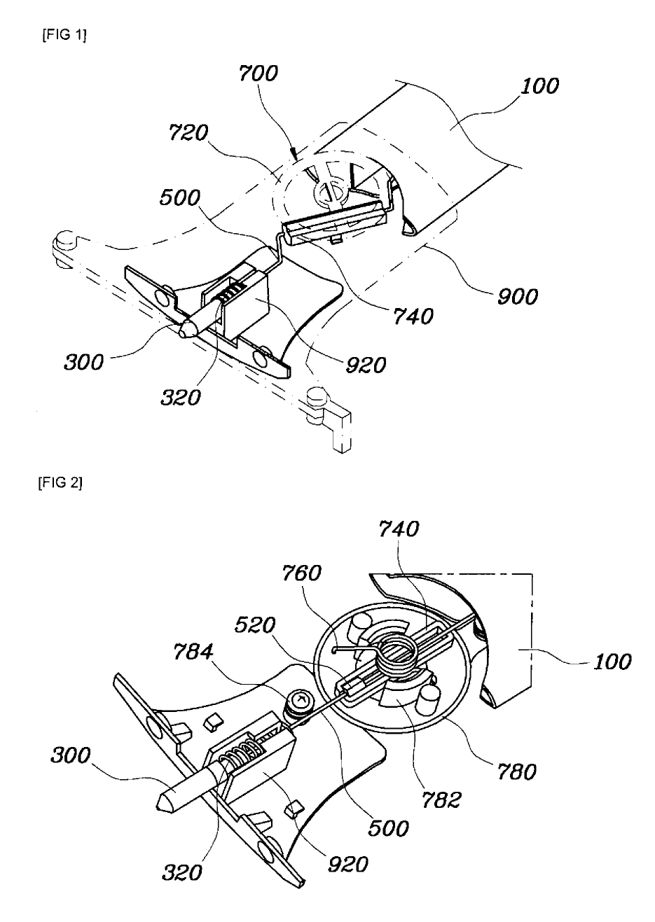

Referring to FIG. 1, the cross bar of the roof carrier for vehicles according to an exemplary embodiment of the present invention includes locking pins 300, a wire 500, and a handle 700. The locking pins 300 are provided on both distal ends of a bar body 100 of the cross bar in such a way as to be elastically ejected out and be selectively locked to side bars (not shown). The wire 500 is provided in the bar body 100, and couples the locking pins 300 to each other. The handle 700 holds the wire 500 between the locking pins 300. Thus, when the handle 700 is rotated by a user, the wire 500 is wound, so that the locking pins 300 are retracted into the bar body 100 of the cross bar but the locking pins 300 is elastically restored to its original state by a pin spring 320 after the handle 700 is released.

That is, the locking pins 300 are normally protruded out by a restoring force of the pin spring 320. Meanwhile, when the handle 700 is operated by a user, the locking pins 300 are retracted into the bar body 100. The locking pins 300, which are provided on both sides of the bar body 100, are coupled to each other by one wire 500. The handle 700 is provided on a portion of the wire 500 so that when the handle 700 is turned by a user, the wire 500 is wound and pulls the locking pins 300 into the bar body 100 and thus the bar body 100 is released from the side bars. After the cross bar is released from the side bars, the position of the bar body 100 is readjusted. Subsequently, the handle 700 is released from a user's hand. At this time, the locking pins 300 are ejected out again by a restoring force of the pin spring 320, and are thus inserted into pin insert holes (not shown) in the side bars. Thereby, the bar body 100 is secured at its adjusted position.

In another exemplary embodiment of the present invention, a mounting bracket 900 is provided on the bar body 100. The mounting bracket 900 maybe provided on only one end of the bar body 100, or may be provided on each of opposite ends of the bar body 100. A locking pin 300, provided on an associated end of the bar body 100, and the handle 700 are mounted to the mounting bracket 900. Preferably, the locking pin 300 is biased by the pin spring 320, wherein the pin spring 320 is disposed in a pin holder 920 provided on the mounting bracket 900 such that the locking pin 300 is elastically ejected when the handle 700 is released. The handle 700 are mounted to the mounting bracket 900. The movement of the locking pin 300 is restricted by the pin holder 920 when the locking pin 300 is retracted into the bar body 100.

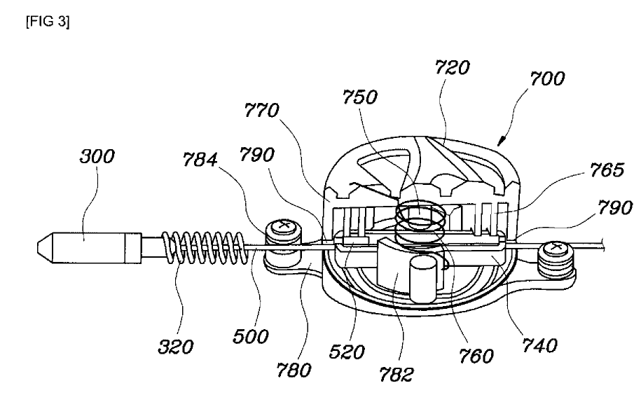

The mounted parts of the cross bar will be described in detail with reference to FIGS. 2 and 3. Preferably, the handle 700 is provided with a grip part 720, a hinge shaft 750, a base part 780, a shaft spring 760, and a takeup part 740.

A lower portion of the grip part 720 is slidably inserted into upper portion of the mounting bracket 900. The hinge shaft 750 extends substantially from a center portion of the grip part 720 onto the takeup part 740 positioned under the hinge shaft 750. Rotating force is applied to the grip part 720 by a shaft spring 760 or a user as explained later.

The base part 780 is provided under the takeup part 740 and is secured to bottom portion of the mounting bracket 740. The takeup part 740 is rotatably placed between lower portion of the hinge shaft 750 and the base part 780 and coupled by an activation portion 765 of the grip part 720. The activation portion 765 of the grip part 720 extends under the grip part 720 around the hinge shaft 720 substantially onto the base part 780 and is configured to couple an outer portion of the takeup part 740. The grip part 720 further comprises a receiving slot 790 along a portion of outer circumference 770 of the grip part 720 and circumference of the activation portion 765 to allow the wire 500 to be wound or unwound through the receiving slot 790.

The shaft spring 760 is provided around the hinge shaft 750 in such a way that both ends of the shaft spring 760 are supported by the grip part 720 and the base part 780 respectively. The takeup part 740 is rotatably provided between the hinge shaft 750 and the base part 780 as set forth above, and the wire 500 passes through outer circumference 770 of the grip part 720 via the receiving slot 790 and the takeup part 740. At this configuration, the grip part 720 of the handle 700 are coupled to the takeup part 740 of the handle 700 via the activation portion 765 of the grip part 720, and the lower portion of the grip part 720 is slidably mounted on the base part 780 secured to the mounting bracket 900. Since upper portion of the grip part 720 is exposed to the outside of the mounting bracket 900, a user can turn or release the grip part 720 and then the hinge shaft 750 serves as the axis of rotation of the grip part 720. In an exemplary embodiment of the present invention, the takeup part 740 has the shape of a bar, and the wire 500 passes through the takeup part 740. Thereby, when the grip part 720 is rotated by the user, the wire 500 is wound by the takeup part 740 which is rotated synchronously by the activation portion 765 of the grip part 720. The base part 780 is secured to the mounting bracket 900.

Preferably, stoppers 782 are provided on the base part 780 in such a way as to be placed on opposite sides of the takeup part 740 with respect to a longitudinal direction thereof, and function to limit the rotation of the takeup part 740 with a predetermined rotation angle. The predetermined rotation angle of the takeup part 740 is determined by width of an opening between the stoppers 782.

Preferably, a locking projection 520 is provided on the wire 500 positioned inside the takeup part 740, and is locked in the takeup part 740 along a longitudinal direction thereof, thus preventing the wire 500 from slipping when the takeup part 740 rotates.

At least a guide part 784 is preferably provided on the base part 780 in such a way as to be positioned substantially next to the wire 500, and guides the wire 500 so that it is wound without deviating from a predetermined course. In an exemplary embodiment of the present invention, the guide part 784 may be disposed substantially in a longitudinal direction of the locking pin 300 and the takeup part 740 to point-support the wire 500. In an exemplary embodiment of the present invention, the guide parts 784 are disposed in a rotational direction of the takeup part 740 turned by a user as shown in FIG. 2. Meanwhile, guide parts may be provided on both sides of the base part 780 so as to allow the wire 500 to be stably wound. The guide part 784 has the shape of a roller to support the wire 500 when the wire 500 is wound. However, the number, arrangement and shape of the guide parts 784 can be variously embodied by a person of ordinary skill in the art based on the teachings contained herein.

The entire operation of mounting the cross bar is as follows. When a user turns the grip part 720 of die handle 700 clockwise, the takeup part 740 winds the wire 500. At this time, each locking pin 300 is moved inward the bar body 100 by the wound wire 500, so that the cross bar can slide along the side bars. After the cross bar is located at a desired position, the grip part 720 is released from the user's hand. At this time, the takeup part 740 returns to its original position by the released shaft spring 760, and each locking pin 300 is ejected out by the pin springs 320 and the unwound wire 500 to be inserted into the corresponding pin insert hole in each side bar.

As described above, the present invention provides a cross bar of a roof carrier for vehicles, which manipulates locking pins using one wire, thus achieving a simple construction.

Further, the present invention provides a cross bar of a roof carrier for vehicles, which uses a rotating-type handle, thus having a simpler internal structure than a cross bar using a pull-type handle, therefore increasing the durability of parts and reducing the manufacturing cost.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A cross bar of a roof carrier for vehicles, which is transversely mounted between side bars provided on both sides of a roof and is movably fastened between the side bars, the cross bar comprising:
at least a locking pin provided on opposite ends of a bar body of the cross bar and capable of being elastically ejected out;
a wire provided in the bar body and coupling the locking pins to each other; and
a handle provided between the locking pins to hold the wire, and constructed to be rotated to wind the wire and thus retract the locking pin into the bar body of the cross bar and constructed to be elastically restored to an original state thereof to unwind the wire when the handle is released.

2. The cross bar as set forth in claim 1, wherein the handle comprises:
a hinge shaft configured to vertically pass through the bar body;
a grip part provided on an upper end of the hinge shaft and rotatable with respect to the hinge shaft by a rotating force, wherein a lower portion of the grip part is configured to be rotatably inserted into a portion of the bar body;
a base part provided under a lower end of the hinge shaft and secured to the bar body, wherein the lower part of the grip part is rotatably mounted onto the base part;
a shaft spring provided around the hinge shaft, wherein both ends of the shaft spring are supported by the grip part and the base part respectively; and
a takeup part rotatably provided between the hinge shaft and base part, wherein the wire passes through the lower portion of the grip part and the takeup part, and the takeup part is coupled to the grip part.

3. The cross bar as set forth in claim 2, wherein the grip part further comprises:
an activation portion extending downwards from the upper portion of the grip part and disposed substantially around the hinge shaft, the activation portion being coupled to a portion of the takeup part to rotate the takeup part; and
a receiving slot formed along a portion of outer circumference of the grip part and a portion of circumference of the activation portion to receive the wire.

4. The cross bar as set forth in claim 2, wherein stoppers are provided on the base part and placed respectively on opposite sides of the takeup part with respect to a longitudinal direction thereof, and serves to limit rotation of the takeup part.

5. The cross bar as set forth in claim 4, wherein one opening between stoppers is configured to face one of the at least a locking pin with a first predetermined angle and the other opening between stoppers is configured to face the other of the at least a locking pin with a second predetermined angle.

6. The cross bar as set forth in claim 5, the first predetermined angle and the second predetermined angle are substantially the same.

7. The cross bar as set forth in claim 2, wherein a locking projection is provided on a portion of the wire positioned inside the takeup part, and is locked to the takeup part along a longitudinal direction thereof, thus preventing the wire from slipping when the takeup part rotates.

8. The cross bar as set forth in claim 2, wherein at least a guide part is provided on the base part and positioned substantially next to the wire, and allows the wire to be wound without deviating from a predetermined course.

9. The cross bar as set forth in claim 8, wherein the at least a guide part is positioned in a rotational direction of the grip part turned by a user.

10. The cross bar as set forth in claim 8, wherein the at least a guide part includes a roller to point-support the wire.

11. The cross bar as set forth in claim 1, wherein at least a mounting bracket is provided on at least an end of the bar body, and one of the at least a locking pin, provided on an associated end of the bar body, and the handle are mounted to the mounting bracket, the locking pin being connected via a pin spring to a pin holder provided on the mounting bracket such that the locking pin is elastically ejected by the locking pin when the handle is released.

12. The cross bar as set forth in claim 11, wherein the handle comprises:
a grip part, wherein a lower portion of the grip shaft is slidably inserted into a portion of the mounting bracket, the grip part subjected to a rotating force;
a hinge shaft extending downwards substantially from a center of an upper portion of the grip part, wherein the grip part is rotatable with respect to the hinge shaft by the rotating force;
a takeup part rotatably provided under the hinge shaft, wherein the wire passes through the lower part of the grip part and the takeup part, and the takeup part is coupled to the grip part;
a base part provided under the takeup part and secured to the mounting bracket; and
a shaft spring provided around the hinge shaft, wherein both ends of the shaft spring are supported by the grip part and the base part respectively.

13. The cross bar as set forth in claim 12, wherein the grip part further comprises:
an activation portion extending downwards from the upper portion of the grip part and disposed substantially around the hinge shaft the activation portion being coupled to a portion of the takeup part to rotate the takeup part; and
a receiving slot formed along a portion of outer circumference of the grip part and a portion of circumference of the activation portion to receive the wire.

14. The cross bar as set forth in claim 12, wherein stoppers are provided on the base part and placed respectively on opposite sides of the takeup part with respect to a longitudinal direction thereof, and serve to limit rotation of the takeup part.

15. The cross bar as set forth in claim 14, wherein one opening between stoppers is configured to face one of the at least a locking pin with a first predetermined angle and the other opening between stoppers is configured to face the other of the at least a locking pin with a second predetermined angle.

16. The cross bar as set forth in claim 15, the first predetermined angle and the second predetermined angle are substantially the same.

17. The cross bar as set forth in claim 12 wherein a locking projection is provided on a portion of the wire positioned inside the takeup part, and is locked to the takeup par along a longitudinal direction thereof, thus preventing the wire from slipping when the takeup part rotates.

18. The cross bar as set forth in claim 12, wherein at least a guide part is provided on the base part and positioned substantially next to the wire and, allows the wire to be wound without deviating from a predetermined course.

19. The cross bar as set forth in claim 18, wherein the at least a guide part is positioned in a rotational direction of the grip part tuned by a user.

20. The cross bar as set forth in claim 18, wherein the at least a guide part includes a roller to point-support the wire.
